(19) United States
(12) Patent Application Publication
(10) Pub. No.: US 2026/0192308 A1
(43) Pub. Date: Jul. 9, 2026

(54) FLOTATION REAGENT AND APPLICATION THEREOF, AND METHOD FOR SYNCHRONOUSLY RECOVERING FLUORITE AND RARE EARTH FROM FLUORITE-TYPE RARE EARTH ORES

(71) Applicant: IMUMR, Chinese Academy of Geological Sciences, Chengdu (CN)

(72) Inventors: Wenliang Xiong, Chengdu (CN); Nengyun Liu, Chengdu (CN); Lijun Zhang, Chengdu (CN); Da Chen, Chengdu (CN); Huijie Lin, Chengdu (CN); Yao Guo, Chengdu (CN); Zheng Zhou, Chengdu (CN)

(21) Appl. No.: 18/633,484

(22) Filed: Apr. 11, 2024

(30) Foreign Application Priority Data
Apr. 19, 2023 (CN) 202310420318.4

(51) Int. Cl. B03D 1/012; B03D 1/008; B03D 1/016

(52) U.S. Cl. CPC B03D 1/012; B03D 1/008; B03D 1/016; B03D 2201/007; B03D 2201/02; B03D 2203/04

(57) ABSTRACT

The present disclosure provides a flotation reagent and application thereof. The flotation reagent includes a collector and an inhibitor. The collector includes fatty acid, alkylaminopropionic acid, and sulfobetaine. The inhibitor includes an aromatic sulfonate polycondensate, water glass, lignosulfonate, and a tannin extract. The present disclosure further provides a method for synchronously recovering fluorite and rare earth from fluorite-type rare earth ores, including: grinding ores to obtain first slurry; regulating the first slurry to be alkaline to obtain second slurry; adding first inhibitor including an aromatic sulfonate polycondensate, water glass, lignosulfonate, and a tannin extract, and performing stirring and mixing to obtain third slurry; adding a first collector including fatty acid, alkylaminopropionic acid, and sulfobetaine, and performing stirring and mixing to obtain fourth slurry; performing aerated flotation on the fourth slurry to obtain a foam product; and performing concentration on the foam product to obtain a mixed concentrate.

### CROSS-REFERENCE TO RELATED APPLICATION

This application claims priority to Chinese patent application No. 202310420318.4, filed on Apr. 19, 2023, which is incorporated herein by reference in its entirety.

### TECHNICAL FIELD

The present disclosure relates to the field of mineral flotation technology, in particular to a flotation reagent and application thereof, and a method for synchronously recovering fluorite and rare earth from fluorite-type rare earth ores.

### BACKGROUND

Rare earth, as a crucial strategic mineral resource, is crucial for social and economic development, and plays a crucial role in the fields of national defense and security, as well as new energy technology. Countries around the world, including China, Europe, the United States, Canada, the European Union, and others, have classified rare earth as a key material for high-tech applications and formulated relevant strategies. Fluorite (CaF₂) is currently the main source of fluorine resources, and fluorine (F), as an indispensable chemical substance, is widely used in fields such as new energy, new materials, optoelectronics, and metallurgy. Therefore, fluorite is known as the second rare earth.

Fluorite-type rare earth ores contain both rare earth and fluorite, which are two useful minerals. Fluorite-type rare earth ores are mostly carbonate rock-type rare earth ores associated with fluorite minerals. The reserve of the associated fluorite therein is relatively large, which is a potential resource to ensure the safe supply of fluorite as a fluorine resource. Therefore, the comprehensive recovery and utilization of rare earth and fluorite in fluorite-type rare earth ores is of great significance.

### SUMMARY

In one aspect, the present disclosure provides a flotation reagent, including a collector and an inhibitor; the collector including fatty acid, alkyl aminopropionic acid, and sulfobetaine; the inhibitor including an aromatic sulfonate polycondensate, water glass, lignosulfonate, and a tannin extract.

In some embodiments, the fatty acid includes at least one of oleic acid, oxidized paraffin soap, tall oil, and naphthenic acid.

In some embodiments, the molecular formula of the alkyl aminopropionic acid is RNHCH₂CH₂COOH, where R is substituted or unsubstituted C₁₀-C₁₈ hydrocarbyl.

In some embodiments, in the molecular formula, R is substituted C₁₀-C₁₈ hydrocarbyl, and the substituted C₁₀-C₁₈ hydrocarbyl is obtained by respectively and independently substituting one or more hydrogen atoms in unsubstituted C₁₀-C₁₈ hydrocarbyl with halogen, alkyl, methoxy, aryl, or heteroaryl.

In some embodiments, the molecular formula of the sulfobetaine is CH₃ (CH₂)ₙ₁N⁺(CH₃)₂(CH₂)ₘ₁SO₃⁻, where n1=7-17, and n1 is an integer; m1≥2, and m1 is an integer.

In some embodiments, the molecular formula of the sulfobetaine is CH₃(CH₂CH₂O)ₙ₂N⁺(CH₃)₂(CH₂)ₘ₂SO₃⁻, where n2=7-17, and n2 is an integer; m2≥2, and m2 is an integer.

In some embodiments, the aromatic sulfonate polycondensate is a sodium salt of a 2-naphthalenesulfonic acid-formaldehyde polymer.

In some embodiments, the sodium salt of the 2-naphthalenesulfonic acid-formaldehyde polymer has a structure expressed by formula (I):

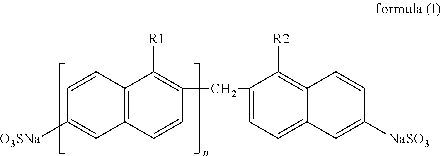

where R1 is selected from the group consisting of hydrogen atom, methyl and benzyl; R2 is the same as R1; n=1-5, and n is an integer.

In some embodiments, the aromatic sulfonate polycondensate has a structure expressed by formula (II):

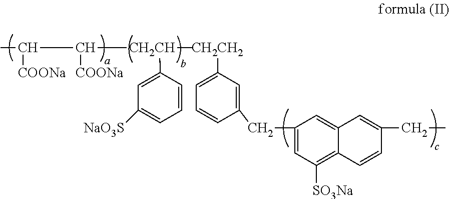

where a+b+c=80-400, and a, b, and c are all positive integers.

In some embodiments, the weight ratio of the fatty acid to the alkyl aminopropionic acid to the sulfobetaine is (5-8):(1-3):(1-3); and/or, the weight ratio of the aromatic sulfonate polycondensate to the water glass to the lignosulfonate to the tannin extract is (30-50):(20-40):(10-30):(5-15).

In another aspect, the present disclosure provides Application of the flotation reagent according to any one of embodiments above to flotation separation of fluorite-type rare earth ores.

In some embodiments, the flotation reagent is applied to synchronously recovering fluorite and rare earth from the fluorite-type rare earth ores.

In some embodiments, the fluorite-type rare earth ores include fluorite, rare earth, and gangue minerals.

In yet another aspect, the present disclosure provides a method for synchronously recovering fluorite and rare earth from fluorite-type rare earth ores, including: grinding raw ores to obtain first slurry; regulating the first slurry to be alkaline to obtain second slurry; adding a first inhibitor to the second slurry, and performing first stirring and mixing to obtain third slurry, the first inhibitor including an aromatic sulfonate polycondensate, water glass, lignosulfonate, and a tannin extract; adding a first collector to the third slurry, and performing second stirring and mixing to obtain fourth slurry, the first collector including fatty acid, alkyl aminopropionic acid, and sulfobetaine; performing first aerated flotation on the fourth slurry to obtain a first foam product; and performing concentration on the first foam product to obtain a mixed concentrate including fluorite and rare earth.

In some embodiments, the fluorite-type rare earth ores include gangue minerals in addition to the fluorite and the rare earth.

In some embodiments, the regulating the first slurry to be alkaline includes: regulating the pH value of the first slurry to 8-9 by using a first regulator.

In some embodiments, the method further includes: regulating the mixed concentrate to be acidic to obtain fifth slurry; adding a second inhibitor to the fifth slurry, and performing third stirring and mixing to obtain sixth slurry, the second inhibitor including an aromatic sulfonate polycondensate, water glass, lignosulfonate, and a tannin extract; adding a second collector to the sixth slurry, and performing fourth stirring and mixing to obtain seventh slurry, the second collector including fatty acid, alkyl aminopropionic acid, and sulfobetaine; and performing second aerated flotation on the seventh slurry to obtain a second foam product and a bottom product, the second foam product being a rare-earth-enriched substance, the bottom product being a fluorite-enriched substance.

In some embodiments, the method further includes: performing first strong magnetic separation on the rare-earth-enriched substance to obtain a magnetic product, the magnetic product being a rare earth concentrate.

In some embodiments, the method further includes: performing second strong magnetic separation on the fluorite-enriched substance to obtain a non-magnetic product, the non-magnetic product being a fluorite concentrate.

In some embodiments, the regulating the mixed concentrate to be acidic includes regulating the pH value of the mixed concentrate to 4-5 by using a second regulator.

### DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings. In addition, the accompanying drawings in the following description may be regarded as schematic diagrams, and are not limitations on actual sizes of products, actual processes of methods and actual timings of signals involved in the embodiments of the present disclosure.

FIG. 1 illustrates a flowchart of a method for synchronously recovering fluorite and rare earth from fluorite-type rare earth ores according to some embodiments of the present disclosure.

FIG. 2 illustrates a flowchart of another method for synchronously recovering fluorite and rare earth from fluorite-type rare earth ores according to some embodiments of the present disclosure.

FIG. 3 illustrates a flowchart of yet another method for synchronously recovering fluorite and rare earth from fluorite-type rare earth ores according to some embodiments of the present disclosure.

FIG. 4 illustrates a flowchart of an ore dressing process in embodiment 1 of the present disclosure.

FIG. 5 illustrates a flowchart of an ore dressing process in embodiment 2 of the present disclosure.

FIG. 6 illustrates a flowchart of an ore dressing process in a closed-loop experiment in comparative example 3 of the present disclosure.

FIG. 7 illustrates a flowchart of an ore dressing process in a closed-loop experiment in comparative example 4 of the present disclosure.

### DETAILED DESCRIPTION OF THE EMBODIMENTS

Technical solutions in some embodiments of the present disclosure will be described clearly and completely below with reference to the accompanying drawings. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example” and “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms such as “first” and “second” are used for descriptive purposes only, and are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a plurality of” or “the plurality of” means two or more unless otherwise specified.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

As used herein, the term such as “approximately” or “substantially” includes a stated value and an average value within an acceptable range of deviation of a particular value determined by a person of ordinary skill in the art, considering measurement in question and errors associated with measurement of a particular quantity (i.e., limitations of a measurement system).

There are significant technical difficulties in the ore dressing of the comprehensive utilization of fluorite-type rare earth ores. The color of fluorite in the fluorite-type rare earth ores is generally dark, usually purple or even purple black. Scholars have studied the float ability of colorless fluorite, green fluorite, and purple fluorite. They have found that colorless fluorite has low sodium oleate adsorption capacity and smaller surface roughness, and its float ability is better than that of green fluorite and purple fluorite; purple fluorite has high sodium oleate adsorption capacity and surface roughness, and its recovery rate is lower than that of green fluorite and colorless fluorite. The fluorite in the fluorite-type rare earth ores is mostly purple fluorite with poor float ability, and this iron-stained purple fluorite has a certain degree of weak magnetism, making it difficult to effectively separate it from weakly magnetic rare earth ores by adopting strong magnetic separation technology.

In China, the grade of fluorite (CaF₂) in the fluorite-type rare earth ores is usually less than 20%, and fluorite is associated with gangue minerals such as calcite and barite. On this basis, since fluorite and calcite have the similar surface properties and both are calcium-containing minerals, calcium ions on their surfaces can interact strongly with commonly used collectors without any difference. At the same time, dissolved ions on the surfaces of fluorite and calcite salt minerals undergo chemical reactions and surface transformations. The dissolved ions of one mineral adsorb on the surface of the other mineral, causing the surface properties of fluorite and calcite to get close to each other and the difference in float ability to further narrow, resulting in similar float ability and difficulty in flotation separation.

At present, in order to achieve the goal of comprehensive recovery and utilization of rare earth and fluorite in the fluorite-type rare earth ores, the ore dressing process basically adopts a step-by-step process, that is, flotation of rare earth minerals is performed firstly, and then fluorite is comprehensively recovered from the rare earth tailings after the flotation of the rare earth minerals. In the flotation reagents involved in this process, the collectors used for the flotation of the rare earth minerals are usually various mature hydroxamic acids, and a large amount of water glass is used to inhibit fluorite and other gangue minerals. Based on this, the research focus of flotation reagents mainly focuses on the recovery of fluorite from the rare earth tailings after flotation. In this case, the combination use of reagents is the key to solving the problem.

In an implementation, a collector with slightly weaker but better selectivity for fluorite and one of other surfactants are jointly used with a collector with strong but poor selectivity for fluorite, which can usually effectively improve fluorite flotation indicators. For example, a mixed collector of sodium naphthenate and fatty acid, a mixed collector of sodium oleate and ethylenediamine phosphate, a mixed collector of oxidized paraffin soap and alkyl trimethyldiamine, or a mixed collector of sodium oleate and sodium dodecyl sarcosine is selected. A mixed inhibitor instead of a single inhibitor is usually used to inhibit gangue minerals. Reasonable selection and joint use of corresponding types of inhibitors based on the types of gangue minerals in fluorite ores can significantly improve the flotation fluorite concentrate indicators. For example, a mixed inhibitor of sodium humate, water glass, and tannin extract, a mixed inhibitor of acidified water glass, tannin extract, and ferrous sulfate, or a mixed inhibitor of water glass and aluminum sulfate is selected. Compared with using water glass alone, jointly using water glass with other organic or inorganic inhibitors can significantly improve the grade and recovery rate of the fluorite concentrate after flotation.

It should be noted that in order to achieve the comprehensive recycling and utilization of rare earth and fluorite resources, hydroxamic acid collectors are usually used as rare earth mineral collectors in the ore dressing process of fluorite-type rare earth ores. At the same time, inhibitors mainly composed of a large amount of water glass are used to forcefully inhibit the flotation of other calcium, barium, and other gangue minerals, including fluorite. In addition, by adding foaming agents to compensate for the weak foaming ability of some aromatic hydroxamic acid collectors, priority is given to the flotation and recovery of rare earth minerals. This process has the following defects: 1) using hydroxamic acid as a rare earth mineral collector and cooperating with a large amount of inhibitors to inhibit gangue minerals will cause excessive inhibition of fluorite minerals, which is not conducive to the subsequent flotation and recovery of fluorite from rare earth tailings after flotation; 2) due to the chelation between hydroxamic acid and iron ions, hydroxamic acid has a strong chelating effect on iron-stained calcium and barium salt gangue minerals (such as calcite and barite); in the slurry during rare earth flotation, iron-stained calcium and barium salt gangue mineral fine mud will firmly adsorb a large amount of hydroxamic acid collectors, while in the flotation of fluorite from the tailings, this part of iron-stained calcium and barium salt gangue minerals that adsorb hydroxamic acid is difficult to be inhibited again, which increasing the difficulty in recovering fluorite from rare earth tailings after flotation; 3) rare earth hydroxamic acid collectors are mostly aromatic hydroxamic acids, which have a high cost and certain toxicity.

In view of this, an embodiment of the present disclosure provides a flotation reagent. The floatation reagent provided in this embodiment of the present disclosure includes a collector and an inhibitor. The collector includes fatty acid, alkyl aminopropionic acid, and sulfobetaine. The inhibitor includes an aromatic sulfonate polycondensate, water glass, lignosulfonate, and a tannin extract.

It is worth noting that in the flotation reagent provided in this embodiment of the present disclosure, the function of the collector is to change the hydrophobicity of the surface of the fluorite-type rare earth ores to make the floating rare earth ore particles and fluorite ore particles easy to adhere to bubbles, thus improving the float ability of rare earth and fluorite; the function of the inhibitor is to enhance the hydrophilicity of the surface of gangue minerals (such as barite and calcite) during flotation, thus effectively destroying or weakening the adsorption of gangue minerals on the collector. Therefore, the flotation reagent provided in this embodiment of the present disclosure can not only synchronously recover rare earth and fluorite from the fluorite-type rare earth ores, but also compensate for the unsatisfactory separation effect of direct magnetic separation of the mixed concentrate including rare earth and fluorite, and improve the comprehensive utilization efficiency of the fluorite-type rare earth ores.

It should be noted that the fatty acid is a fluorite collector, which has good collection performance and selectivity to fluorite.

In some embodiments, the fatty acid may include at least one of oleic acid, oxidized paraffin soap, tall oil, and naphthenic acid.

It is easy to understand that the oleic acid can not only be fatty acid with a chemical formula of C₁₈H₃₄O₂, but also be fatty acid salt (i.e., oleate) obtained through the reaction of the fatty acid with the chemical formula of C₁₈H₃₄O. The effects of the two are essentially the same.

In some examples, the oleate may be sodium oleate.

It should be noted that the alkyl aminopropionic acid is an amphoteric surfactant, which can improve the selectivity of the fatty acid (i.e., the fluorite collector) to fluorite.

In some embodiments, the molecular formula of the alkyl aminopropionic acid is RNHCH₂CH₂COOH, where R is substituted or unsubstituted C₁₀-C₁₈ hydrocarbyl.

In some examples, R is substituted C₁₀-C₁₈ hydrocarbyl, and the substituted C₁₀-C₁₈ hydrocarbyl is obtained by respectively and independently substituting one or more hydrogen atoms in unsubstituted C₁₀-C₁₈ hydrocarbyl with halogen, alkyl, methoxy, aryl, or heteroaryl.

In some other examples, R is unsubstituted C₁₀-C₁₈ hydrocarbyl.

Exemplarily, the alkyl aminopropionic acid is C₁₄ N-tetradecyl-β-alanine.

It is easy to understand that the N-tetradecyl-β-alaninecan not only be N-tetradecyl-β-alanine, but also be N-tetradecyl-β-alaninesalt obtained through reaction of N-tetradecyl-β-alanine. The effects of the two are essentially the same.

In some examples, the N-tetradecyl-β-alaninesalt may be sodium N-tetradecyl-β-alanine.

It should be noted that the sulfobetaine is an amphoteric surfactant, which can enhance the ability of the fatty acid (i.e., the fluorite collector) to collect rare earth.

In some embodiments, the molecular formula of the sulfobetaine is CH₃(CH₂)ₙ₁N⁺(CH₃)₂(CH₂)ₘ₁SO₃⁻, where n1=7-17, and n1 is an integer; m1≥2, and m1 is an integer.

In some example, n1=17, and m1=2.

Exemplarily, the sulfobetaine may be octadecylhydroxysulfobetaine.

In some other embodiments, the molecular formula of the sulfobetaine is CH₃ (CH₂CH₂O)ₙ₂N⁺(CH₃)ₘ₂(CH₂)ₘ₂SO₃⁻, where n2=7-17, and n2 is an integer; m2≥2, and m2 is an integer.

In some example, n2=17, and m2=2.

Therefore, the collector provided in this embodiment of the present disclosure can effectively improve the flotation separation selectivity of useful minerals (i.e., rare earth and fluorite) and gangue minerals (e.g., barite and calcite) in the fluorite-type rare earth ores, thus obtaining a relatively pure mixed concentrate of rare earth and fluorite.

It should be noted that the aromatic sulfonate condensate is a calcite inhibitor, which has a strong inhibitory effect on calcite.

In some embodiments, the aromatic sulfonate polycondensate may be a sodium salt of a 2-naphthalenesulfonic acid-formaldehyde polymer.

In some examples, the sodium salt of the 2-naphthalenesulfonic acid-formaldehyde polymer has a structure expressed by formula (I):

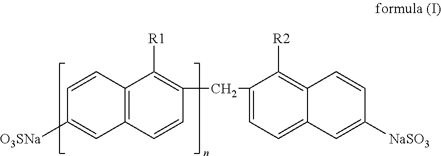

where R1 is selected from the group consisting of hydrogen atom, methyl and benzyl; R2 is the same as R1; n=1-5, and n is an integer.

It should be noted that R2 being the same as R1 means that in any structure expressed by formula (I), R2 and R1 are the same atom or substituent group.

Exemplarily, if R1 is a hydrogen atom, then R2 is also a hydrogen atom.

Further exemplarily, if R1 is methyl, then R2 is also methyl.

Further exemplarily, if R1 is benzyl, then R2 is also benzyl.

In some other examples, the aromatic sulfonate polycondensate has a structure expressed by formula (II):

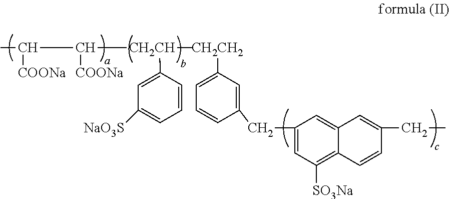

where a+b+c=80-400, and a, b, and c are all positive integers.

It should be noted that the water glass is a gangue mineral inhibitor, which has a certain inhibitory effect on gangue minerals (such as calcite) and has a very small influence on the float ability of fluorite.

In some examples, the water glass may be water glass.

In some other examples, the water glass may be acidic water glass.

Exemplarily, the acidic water glass may be sulfated water glass.

For example, the sulfated water glass may be prepared from dilute sulfuric acid solution and water glass solution of the same mass concentration according to a volume ratio of 2:1.

It should be noted that the lignosulfonate is a barite inhibitor, which can selectively cover the surface of barite to make it hydrophilic.

In some embodiments, the lignosulfonate may be sodium lignosulfonate.

It should be noted that the tannin extract is a calcite inhibitor, which has a certain inhibitory effect on calcite.

In some embodiments, the tannin extract may include at least one of larch tannin extract, bayberry tannin extract, and valonia tannin extract.

In some embodiments, the weight ratio of the fatty acid to the alkyl aminopropionic acid to the sulfobetaine may be (5-8):(1-3):(1-3). For example, it may be 6:2:2.

In some embodiments above, the alkylaminopropionic acid can improve the selectivity of the fatty acid for collecting fluorite, and the sulfobetaine can enhance the ability of the fatty acid to collect rare earth. Mixing the alkylaminopropionic acid, the sulfobetaine, and the fatty acid can achieve synchronous flotation of rare earth and fluorite in the fluorite-type rare earth ores.

In some embodiments, the weight ratio of the aromatic sulfonate polycondensate to the water glass to the lignosulfonate to the tannin extract may (30-50):(20-40):(10-30):(5-15). For example, it may be 40:30:20:10.

In some embodiments above, the aromatic sulfonate condensate has a strong inhibitory effect on calcite. The aromatic sulfonate condensate is introduced into the water glass, the sodium lignosulfonate and the tannin extract. During flotation, the content of gangue minerals (especially calcite) entrained in the foam synchronously floating up in the roughing of rare earth and fluorite can be effectively inhibited through concentration, thus obtaining a mixed concentrate of rare earth and fluorite with low content of gangue minerals.

To sum up, the flotation reagent provided in this embodiment of the present disclosure can not only synchronously recover rare earth and fluorite from the fluorite-type rare earth ores, but also compensate for the unsatisfactory separation effect of direct magnetic separation of the mixed concentrate including rare earth and fluorite, and improve the comprehensive utilization efficiency of the fluorite-type rare earth ores.

In another aspect, an embodiment of the present disclosure further provides application of the flotation reagent according to any one of the embodiments to flotation separation of fluorite-type rare earth ores. For example, it may be application to synchronously recovering fluorite and rare earth from the fluorite-type rare earth ores.

It is worth noting that the application provided in this embodiment of the present disclosure provides a new approach for the comprehensive recycling and utilization of the fluorite-type rare earth ores.

It should be noted that the fluorite-type rare earth ores are carbonate-type rare earth ores associated with fluorite, which may include fluorite, rare earth, and gangue minerals, among which the gangue minerals are composed of useless solid substances associated with useful minerals in the fluorite-type rare earth ores.

In some examples, the gangue minerals may include calcite and quartz. On this basis, exemplarily, the gangue minerals may further include barite.

It is easy to understand that for the flotation of rare earth minerals, fluorite also belongs to a type of gangue minerals. However, in this embodiment of the present disclosure, the gangue minerals do not include fluorite. This is because the purpose of this embodiment of the present disclosure is to separate fluorite and rare earth from other gangue minerals and recover them simultaneously. At this time, rare earth and fluorite are useful minerals, while other gangue minerals are useless minerals.

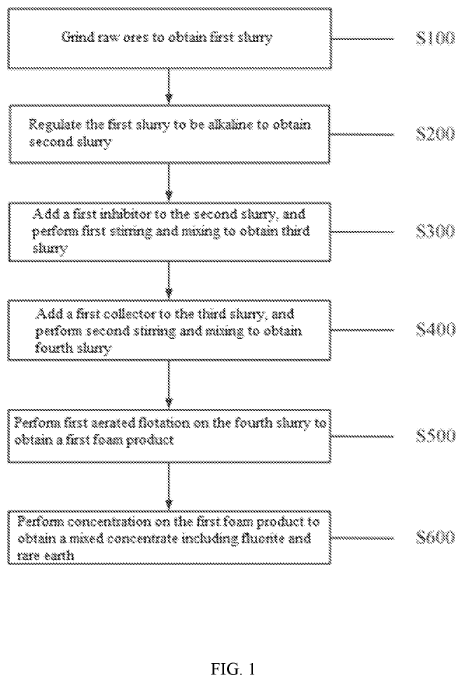

In yet another aspect, an embodiment of the present disclosure further provides a method for synchronously recovering fluorite and rare earth from fluorite-type rare earth ores. Referring to FIG. 1, the method includes steps S100-S600.

In step S100, raw ores are ground to obtain first slurry.

It should be noted that the raw ores are fluorite-type rare earth ores in the embodiment of the present disclosure. That is, the raw ores may further include gangue minerals in addition to fluorite and rare earth.

In some examples, the gangue minerals may include calcite and quartz.

On this basis, exemplarily, the gangue minerals may further include sulfide (such as pyrite). At this time, the method may include the step of performing flotation on the first slurry between step S100 and step S200 to remove sulfur-containing impurities.

It should be noted that the degree of grinding may be selected according to the needs, which is not limited in this embodiment of the present disclosure. Exemplarily, the fineness of grinding may be −0.074 mm 90%, that is, the weight percentage of minerals with a particle size of −0.074 mm in the first slurry may be 90%.

Similarly, the equipment used for grinding may be selected according to the needs, which is not limited in this embodiment of the present disclosure. Exemplarily, the grinding may be performed by using a ball mill.

In step S100, by grinding the raw ores, the particle size of the minerals can be reduced, so that the useful minerals in the minerals can achieve the effect of individual separation as much as possible.

In step S200, the first slurry is regulated to be alkaline to obtain second slurry.

In step S200, by regulating the first slurry to be alkaline to obtain second slurry, acidity and alkalinity with the best float ability can be provided for the minerals to be floated in the second slurry.

In step S300, a first inhibitor is added to the second slurry, and first stirring and mixing is performed to obtain third slurry.

The first inhibitor is the inhibitor in the flotation reagent described according to any one of the embodiments. At this time, the first inhibitor includes an aromatic sulfonate polycondensate, water glass, lignosulfonate, and a tannin extract.

It should be noted that the first inhibitor can effectively reduce the float ability of the gangue minerals in the second slurry, in order to obtain a mixed concentrate including rare earth and fluorite with low gangue content in the subsequent flotation process.

It is easy to understand that the purpose of the first stirring and mixing is to evenly mix the first inhibitor and the second slurry, and its operation time may be selected according to the needs, which is not limited in this embodiment of the present disclosure. Exemplarily, the operation time for the first stirring and mixing may be 3 min.

In step S400, a first collector is added to the third slurry, and second stirring and mixing is performed to obtain fourth slurry.

The first collector is the collector in the flotation reagent according to any one of the embodiments. At this time, the first collector may include fatty acid, alkyl aminopropionic acid, and sulfobetaine.

It should be noted that the first collector has good collection ability for rare earth and fluorite, which can improve the float ability of rare earth and fluorite in the third slurry, and is conducive to synchronous recovery of rare earth and fluorite in the subsequent flotation process.

It is easy to understand that the purpose of the second stirring and mixing is to evenly mix the first collector with the third slurry, and its operation time may be selected according to the needs, which is not limited in this embodiment of the present disclosure.

Exemplarily, the operation time for the second stirring and mixing mentioned above may be 3 min.

In step S500, first aerated flotation is performed on the fourth slurry to obtain a first foam product.

It should be noted that the purpose of the first aerated flotation is to enrich fluorite and rare earth in the first foam product, and its operation conditions may be selected according to the needs, which is not limited in this embodiment of the present disclosure. Exemplarily, the aeration rate of the first aerated flotation may be 2 L/min and the time may be 3 min.

In step S600, concentration is performed on the first foam product to obtain a mixed concentrate including fluorite and rare earth.

It should be noted that the purpose of the concentration is to preliminarily separate rare earth and fluorite, and its times may be selected according to the needs, which is not limited in this embodiment of the present disclosure.

In some examples, the times of the concentration may be six. At this time, the grade of the mixed concentrate is relatively high, and on this basis, further increasing the times of the concentration has less effect on improving the grade of the mixed concentrate. After overall consideration, it can be concluded that six times of concentration are the best choice.

To sum up, the method for synchronously recovering fluorite and rare earth from fluorite-type rare earth ores provided in this embodiment of the present disclosure achieves the synchronous flotation and recovery of rare earth and fluorite in the fluorite-type rare earth ores.

In some embodiments, in step S200, regulating the first slurry to be alkaline includes regulating the pH value of the first slurry to 8-9 by using a first regulator.

It should be noted that the first regulator is an alkaline regulator. By adding the alkaline regulator to the first slurry, the alkalinity of the first slurry can be improved. At this time, with the increase of the amount of the alkaline regulator added, the pH value of the first slurry gradually increases to 8-9. At this time, the float ability of rare earth and fluorite is the best.

It is easy to understand that the alkaline regulator includes various regulators, which may be selected according to the needs and is not limited in this embodiment of the present disclosure. Exemplarily, the alkaline regulator may include sodium hydroxide.

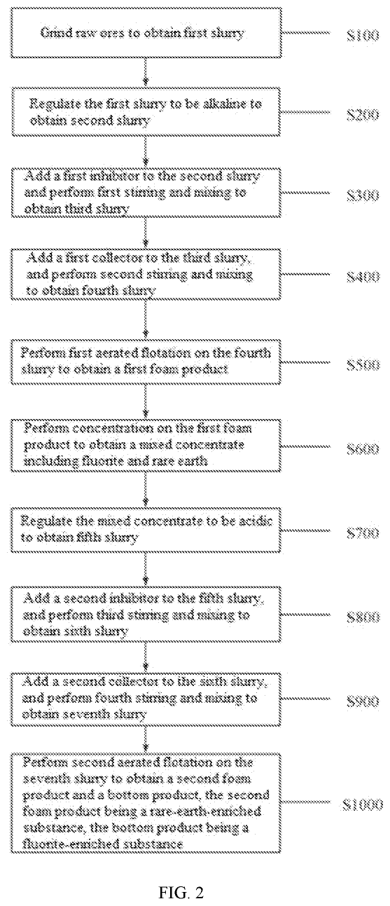

In some embodiments, referring to FIG. 2, the method further includes steps S700-S1000.

In step S700, the mixed concentrate is regulated to be acidic to obtain fifth slurry.

In step S700, regulating the mixed concentrate to be acidic can promote the detachment of the collector from the surface of fluorite.

In step S800, a second inhibitor is added to the fifth slurry, and third stirring and mixing is performed to obtain sixth slurry.

The second inhibitor is the inhibitor in the flotation reagent according to any one of the embodiments. At this time, the second inhibitor includes an aromatic sulfonate polycondensate, water glass, lignosulfonate, and a tannin extract.

The first inhibitor is the inhibitor in the flotation reagent according to any one of the embodiments. At this time, the first inhibitor includes an aromatic sulfonate polycondensate, water glass, lignosulfonate, and a tannin extract.

It should be noted that the second inhibitor can promote the detachment of the collector from the surface of fluorite, thus eliminating the heterocoagulation groups of rare earth and fluorite, which is conducive to the subsequent separation of rare earth and fluorite.

It is easy to understand that the purpose of the third stirring and mixing is to evenly mix the second inhibitor with the fifth mineral slurry, and its operation time may be selected according to the needs, which is not limited in this embodiment of the present disclosure. Exemplarily, the operation time for the third stirring and mixing may be 3 min.

In step S900, a second collector is added to the sixth slurry, and fourth stirring and mixing is performed to obtain seventh slurry.

The second collector is the collector in the flotation reagent according to any one of the embodiments. At this time, the second collector includes fatty acid, alkyl aminopropionic acid, and sulfobetaine.

It should be noted that the second collector can adsorb on the surface of rare earth, thus improving its float ability. On this basis, due to the acidity of the sixth slurry and the addition of the second inhibitor, it is difficult for the second collector to adsorb on the surface of fluorite.

It is easy to understand that the purpose of the fourth stirring mixing is to evenly mix the second collector with the sixth slurry, and its operation time may be selected according to the needs, which is not limited in this embodiment of the present disclosure. Exemplarily, the operation time for the fourth stirring mixing may be 3 min.

In step S1000, second aerated flotation is performed on the seventh slurry to obtain a second foam product and a bottom product. The second foam product is a rare-earth-enriched substance, and the bottom product is a fluorite-enriched substance.

It should be noted that the purpose of the second aerated flotation is to separate rare earth from fluorite, and its operation conditions may be selected according to the needs, which are not limited in this embodiment of the present disclosure. Exemplarily, the aeration rate of the first aerated flotation may be 2 L/min, and the flotation soap scraping time may be 2-3 min.

In some of the embodiments, the method can also compensate for the unsatisfactory separation effect of direct magnetic separation of the mixed concentrate including rare earth and fluorite, thus improving the comprehensive utilization efficiency of the fluorite-type rare earth ores and simultaneously providing a new approach for the purification of the mixed concentrate including rare earth and fluorite.

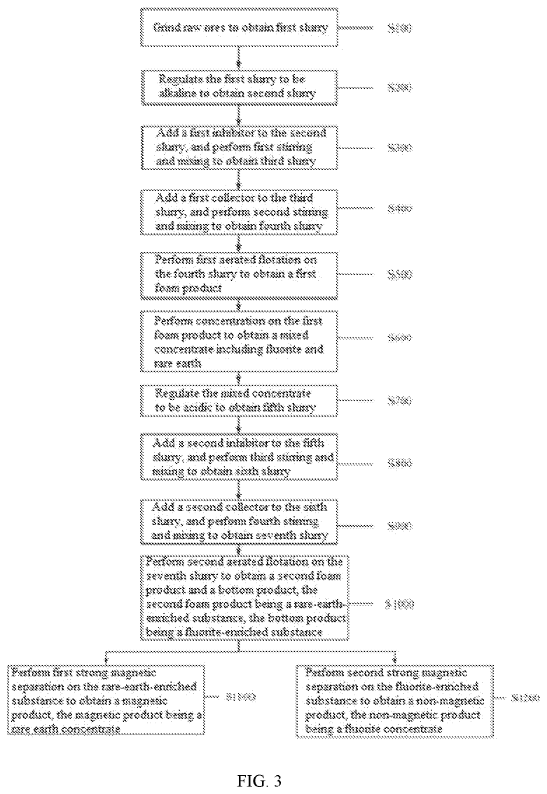

In some embodiments, referring to FIG. 3, the method further includes the following step:

In step S1100, first strong magnetic separation is performed on the rare-earth-enriched substance to obtain a magnetic product. The magnetic product is a rare earth concentrate.

In some of the embodiments, due to the weak magnetism of rare earth, performing the first strong magnetic separation on the rare-earth-enriched substance can separate rare earth minerals from non-magnetic minerals to obtain the rare earth concentrate.

It should be noted that the magnetic field intensity of the first strong magnetic separation may be selected according to the needs, which is not limited in this embodiment of the present disclosure. Exemplarily, the magnetic field intensity of the first strong magnetic separation may be 1.2T.

In some embodiments, referring to FIG. 3, the method further includes the following step:

In step S1200, second strong magnetic separation is performed on the fluorite-enriched substance to obtain a non-magnetic product. The non-magnetic product is a fluorite concentrate.

In some of the embodiments, due to the non-magnetism of fluorite, performing the second strong magnetic separation on the fluorite-enriched substance can separate fluorite and weakly magnetic minerals to obtain the fluorite concentrate.

It should be noted that the magnetic field intensity of the second strong magnetic separation may be selected according to the needs, which is not limited in this embodiment of the present disclosure. Exemplarily, the magnetic field intensity of the second strong magnetic separation may be 1.2T.

In some embodiments, in step S700, regulating the mixed concentrate to be acidic includes regulating the pH value of the mixed concentrate to 4-5 by using a second regulator.

It should be noted that the second regulator is an acidic regulator. By adding the acidic regulator to the mixed concentrate, the acidity of the mixed concentrate can be improved. At this time, as the amount of the acidic regulator increases, the pH value of the mixed concentrate gradually decreases to 4-5, which can promote the detachment of the collector from the surface of fluorite and improve the separation effect of fluorite and rare earth.

It is easy to understand that the acidic regulator includes various acidic regulators, which may be selected according to the needs and are not limited in this embodiment of the present disclosure. Exemplarily, the acidic regulator may include sulfuric acid.

In some of the embodiments, the method provided in this embodiment of the present disclosure adopts a process technology of firstly performing flotation and separation and performing then magnetic separation and purification on the mixed concentrate including fluorite and rare earth. By firstly separating fluorite with certain magnetism, fluorite is prevented from being difficult to separate from weakly magnetic rare earth minerals in subsequent strong magnetic separation operations, which can avoid adverse effects on the separation effect of strong magnetic separation operations, improve the separation effect of rare earth and fluorite, ultimately and significantly improve the grade of rare earth oxide (REO) and recovery rate of the rare earth concentrate, and improve the grade of CaF₂ under the situation that the recovery rate of CaF₂ in the fluorite concentrate does not change greatly.

To sum up, the floatation reagent and the method for synchronously recovering fluorite and rare earth from fluorite-type rare earth ores provided in the embodiments of the present disclosure improve the comprehensive utilization efficiency of rare earth and fluorite in the fluorite-type rare earth ores, and can provide a new approach for the purification of the mixed concentrate including rare earth and fluorite.

In order to objectively evaluate the technical effectiveness of the embodiments of the present disclosure, the following will provide an exemplary description of the method for synchronously recovering fluorite and rare earth from fluorite-type rare earth ores provided in the present disclosure through specific embodiments.

In the following experimental examples and comparative examples, the same inhibitor DRF and collector CRF are used. The inhibitor DRF includes a sodium salt of a 2-naphthalenesulfonicacid-formaldehyde polymer, water glass, sodium lignosulfonate, and a bayberry tannin extract, with a weight ratio of 40:30:20:10. The sodium salt of the 2-naphthalenesulfonicacid-formaldehyde polymer is a mixture of a compound with a structure expressed by formula (III), a compound with a structure expressed by formula (IV), and a compound with a structure expressed by formula (V). The collector CRF includes sodium oleate, sodium N-tetradecyl-β-alanine, and octadecyl hydroxy sulfobetaine, with a weight ratio of 6:2:2.

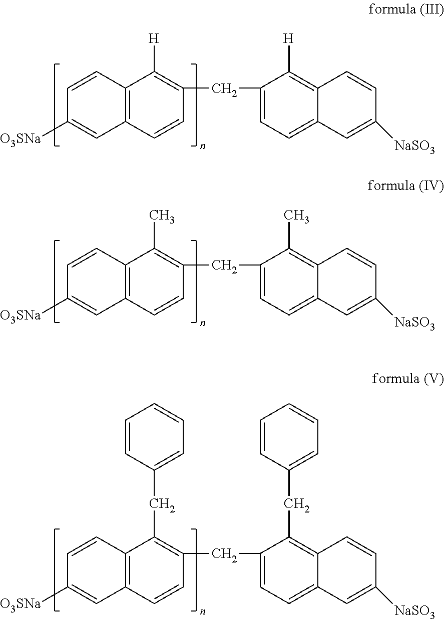

In addition, in the following experimental examples and comparative examples, the adopted fluorite-type rare earth ores, flotation machine, and magnetic separator are all the same. The fluorite-type rare earth ores are fluorite-type rare earth ores associated with gangue minerals such as calcite, barite, and quartz, produced in northern China. The chemical composition of the ore sample is as shown in Table 1.

TABLE 1

| Item | F | Na₂O | MgO | Al₂O₃ | SiO₂ | P₂O₅ | S | Cl | K₂O |
|---|---|---|---|---|---|---|---|---|---|
| Content (%) | — | 0.161 | 0.311 | 25.55 | 34.88 | 0.359 | 11.99 | — | 0.272 |
| Item | Sc₂O₃ | TiO₂ | V₂O₅ | Cr₂O₃ | MnO | Fe₂O₃ | Co₃O₄ | NiO | CuO |
| Content (%) | 0.003 | 3.35 | 0.097 | 0.044 | 0.053 | 14.23 | 0.004 | 0.009 | 0.012 |
| Item | ZnO | GaO | As₂O₃ | SrO | Y₂O₃ | ZrO₂ | Nb₂O₅ | Rb₂O | Rh₂O₃ |
| Content (%) | 0.010 | 0.006 | 0.009 | 0.034 | 0.012 | 0.130 | 0.016 | — | 0.002 |

### Embodiment 1

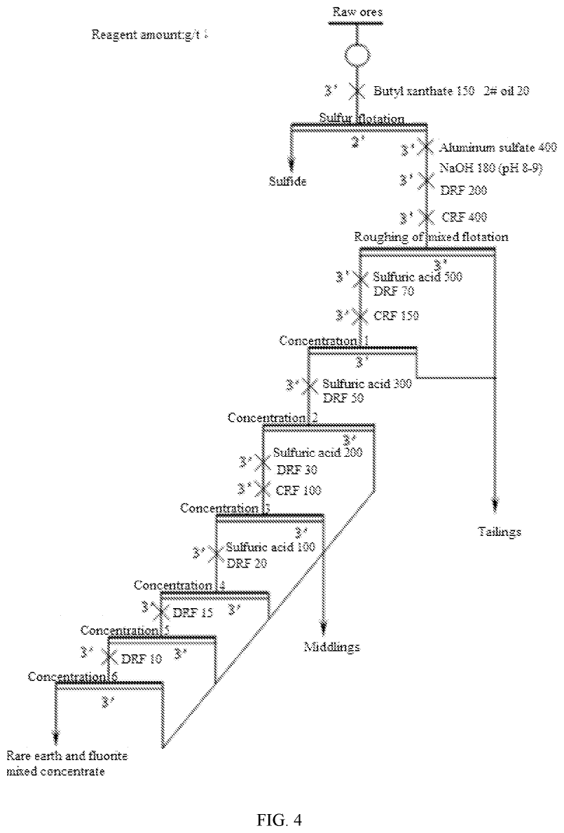

A flotation experiment was performed on the fluorite-type rare earth ores. Referring to FIG. 4, a specific process was as follows:

Firstly, 500 g of raw ores (i.e., fluorite-type rare earth ores) were taken and added with 500 mL of water. A ball mill was used to grind the ores until the weight percentage of minerals with a particle size of −0.074 mm was 90%. Then, the slurry obtained from the grinding was transferred to a flotation cell with a volume of 1.5 L. Butyl xanthate (150 g/t) was added to the slurry and stirring was performed for 3 min. Then, No. 2 oil (20 g/t) was added and stirring was performed for 2 min for flotation. During flotation, the slurry was aerated at an aeration rate of 2 L/min, and flotation foam scraping was performed for 3 min. The obtained foam product (i.e., sulfide) was discarded as sulfur-containing impurities. Aluminum sulfate (400 g/t, to selectively inhibit gangue minerals) was added to the slurry and stirring was performed for 3 min. Then, sodium hydroxide (180 g/t, to regulate the pH value of the slurry to 8-9) and the inhibitor DRF (200 g/t) were sequentially added, and stirring was performed for 3 min. Then, the collector CRF (400 g/t) was added and stirring was performed for 3 min. Finally, roughing of mixed flotation for synchronous recovery of rare earth and fluorite was performed. In the roughing process, the slurry was aerated at an aeration rate of 2 L/min, and flotation foam scraping was performed for 3 min to obtain a first foam product (i.e., rare earth and fluorite mixed coarse concentrate). The slurry in the flotation cell was tailings.

16 Secondly, the first foam product (i.e., rare earth and fluorite mixed coarse concentrate) obtained from roughing of mixed flotation was transferred into a flotation cell with a volume of 0.5 L. Sulfuric acid (500 g/t, to regulate the pH value to 6-7) and the inhibitor DRF (70 g/t) were sequentially added, and stirring was performed for 3 min. Then, the collector CRF (150 g/t) was added and stirring was performed for 3 min to perform first concentration (i.e., concentration 1). In the concentration process, aeration was performed at an aeration rate of 2 L/min, and floatation foam scaping was performed for 3 min to obtain a second foam product and a bottom product. The bottom product was tailings.

Then, the second flotation foam product was transfer into a flotation cell with a volume of 0.5 L. Sulfuric acid (300 g/t, to regulate the pH value to 6-7) and the inhibitor DRF (50 g/t) were sequentially added, and stirring was performed for 3 min to perform second concentration (i.e., concentration 2). In the concentration process, aeration was performed at an aeration rate of 2 L/min, and flotation foam scraping was performed for 3 min to obtain a third foam product and a bottom product. The bottom product was second concentration middlings.

Then, the third foam product was transfer into a flotation cell with a volume of 0.5 L. Sulfuric acid (200 g/t, to regulate the pH value to 6-7) and the inhibitor DRF (30 g/t) were sequentially added, and stirring was performed for 3 min. Then, the collector CRF (100 g/t) was added and stirring was performed for 3 min to perform third concentration (i.e., concentration 3). In the concentration process, aeration was performed at an aeration rate of 2 L/min, flotation foam scraping was performed for 3 min to obtain a fourth foam product and a bottom product. The bottom product was third concentration middlings.

Then, the fourth foam product was transfer into a flotation cell with a volume of 0.5 L. Sulfuric acid (100 g/t, to regulate the pH value to 6-7) and the inhibitor DRF (20 g/t) were sequentially added, and stirring was performed for 3 min to perform fourth concentration (i.e., concentration 4). In the concentration process, aeration was performed at an aeration rate of 2 L/min, and flotation foam scraping was performed for 3 min to obtain a fifth foam product and a bottom product. The bottom product was fourth concentration middlings.

Then, the fourth foam product was transferred into a flotation cell with a volume of 0.5 L. The inhibitor DRF (15 g/t) was added and stirring was performed for 3 min to perform fifth concentration (i.e., concentration 5). In the concentration process, aeration was performed at an aeration rate of 2 L/min, and flotation foam scraping was performed for 3 min to obtain a sixth foam product and a bottom product. The bottom product was fifth concentration middlings.

Finally, the fifth foam product was transferred into a flotation cell with a volume of 0.5 L. The inhibitor DRF (10 g/t) was added and stirring was performed for 3 min to perform sixth concentration (i.e., concentration 6). In the concentration process, aeration was performed at an aeration rate of 2 L/min, and flotation foam scraping was performed for 3 min to obtain a seventh foam product and a bottom product. The bottom product was fourth concentration middlings. The seventh foam product was a rare earth and fluorite mixed concentrate.

It should be noted that starting from the second concentration, the concentration middlings obtained from each concentration were returned to the previous concentration operation according to the sequence.

### Embodiment 2

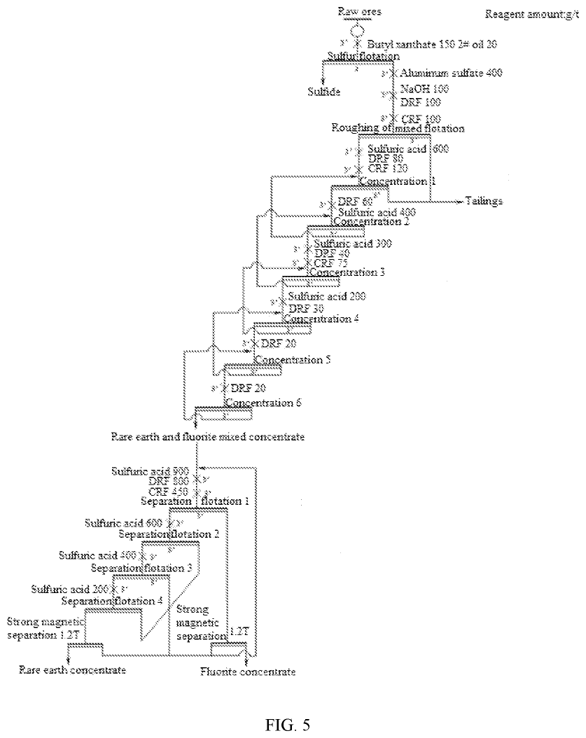

A flotation experiment was performed on the fluorite-type rare earth ores. Referring to FIG. 5, a specific process was as follows:

Firstly, a rare earth and fluorite mixed concentrate was obtained. The difference between the method for obtaining the rare earth and fluorite mixed concentrate in embodiment 2 and the method for obtaining the rare earth and fluorite mixed concentrate in embodiment 1 was as follows:

In the roughing process for the mixed flotation of rare earth and fluorite, the amount of sodium hydroxide used was adjusted to 100 g/t, and the amount of the inhibitor DRF used was adjusted to 100 g/t. In the first concentration process, the amount of sulfuric acid used was adjusted to 600 g/t, the amount of the inhibitor DRF used was adjusted to 80 g/t, and the amount of the collector CRF used was adjusted to 120 g/t. In the second concentration process, the amount of sulfuric acid used was adjusted to 400 g/t, and the amount of the inhibitor DRF used was adjusted to 60 g/t. In the third concentration process, the amount of sulfuric acid used was adjusted to 300 g/t, the amount of the inhibitor DRF used was adjusted to 40 g/t, and the amount of the collector CRF used was adjusted to 75 g/t. In the fourth concentration process, the amount of sulfuric acid used was adjusted to 200 g/t, and the amount of the inhibitor DRF used was adjusted to 30 g/t. In the fifth concentration process, the amount of the inhibitor DRF used was adjusted to 20 g/t. In the sixth concentration process, the amount of the inhibitor DRF used was adjusted to 20 g/t. Other conditions such as the selection and amounts of residual reagents, as well as the steps and parameters of the method, were the same as those in the method in embodiment 1.

Secondly, separation was performed on the obtained rare earth and fluorite mixed concentrate, including the following steps:

In step 1, the seventh foam product (i.e., rare earth and fluorite mixed concentrate) obtained from the sixth concentration was transferred into a flotation cell with a volume of 0.5 L, sulfuric acid (900 g/t, to regulate the pH value to 4-5) and the inhibitor DRF (800 g/t) were sequentially added, stirring was performed for 3 min, then the collector CRF (450 g/t) was added, stirring was performed for 3 min to perform first separation flotation (i.e., separation flotation 1), aeration was performed at an aeration rate of 2 L/min in the flotation process to obtain a first separation flotation foam product and a bottom product, and the bottom product was a fluorite-enriched substance.

In step 2, the first separation flotation foam product was transferred into a flotation cell with a volume of 0.5 L, sulfuric acid (600 g/t, to regulate the pH value to 4-5) was added, stirring was performed for 3 min to perform second separation flotation (i.e., separation flotation 2), aeration was performed at an aeration rate of 2 L/min in the flotation process to obtain a second separation flotation foam product and a bottom product, and the bottom product was a separation flotation fluorite-enriched substance.

In step 3, the second separation flotation foam product was Transfer into a flotation cell with a volume of 0.5 L, sulfuric acid (400 g/t, to regulate the pH value to 4-5) was added, stirring was performed for 3 min to perform third separation flotation (i.e., separation flotation 3), aeration was performed at an aeration rate of 2 L/min in the flotation process to obtain a third separation flotation foam product and a bottom product, and the bottom product was first separation flotation middlings.

In step 4, the third separation flotation foam product was transferred into a flotation cell with a volume of 0.5 L, sulfuric acid (200 g/t, to regulate the pH value to 4-5) was added, stirring was performed for 3 min to perform fourth separation flotation (i.e., separation flotation 4), aeration was performed at an aeration rate of 2 L/min in the flotation process to obtain a fourth separation flotation foam product and a bottom product, and the bottom product was second separation flotation middlings.

The fourth separation flotation foam product was a rare-earth-enriched substance. The bottom products obtained in the second, third and fourth separation flotation were intensively returned to the first separation flotation. The magnetic product obtained from the rare-earth-enriched substance through strong magnetic separation with a magnetic field intensity of 1.2T was a rare earth concentrate, while the non-magnetic product obtained from the fluorite-enriched substance through strong magnetic separation with a magnetic field intensity of 1.2T was a fluorite concentrate. The non-magnetic product obtained from the rare-earth-enriched substance through strong magnetic separation and the magnetic product obtained from the fluorite-enriched substance through strong magnetic separation were combined and cyclically returned back to the first separation flotation.

### Comparative Example 1

Comparative example 1 was adopted and compared with embodiment 1. The process flow and raw ores (i.e., fluorite-type rare earth ore) adopted in comparative example 1 were the same as those in embodiment 1. The difference was only that the same amount of sodium oleate was used in comparative example 1 to replace the collector in embodiment 1.

### Comparative Example 2

Comparative example 2 was adopted and compared with embodiment 1. The process flow and raw ores (i.e., fluorite-type rare earth ore) adopted in comparative example 2 were the same as those in embodiment 1. The difference was only that the same amount of a combined reagent including water glass, lignin, bayberry tannin extract, dextrin and sodium sulfate (with weight ratio of 20:5:1:45:20) was used in comparative example 2 to replace the inhibitor in embodiment 1.

### Comparative Example 3

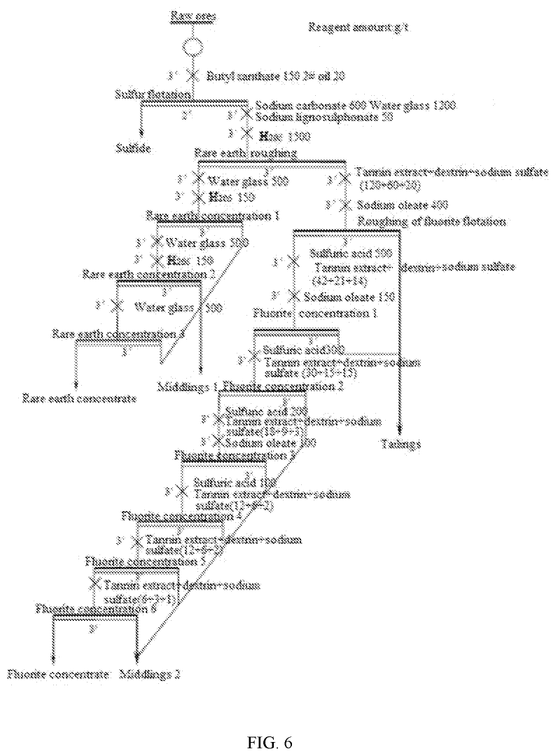

Comparative example 3 was adopted and compared with embodiment 1. A hydroxamic acid collector H205 was firstly used to preferentially float rare earth. Then fluorite was floated from the rare earth tailings. The raw ores used (i.e., fluorite-type rare earth ores) were the same as those in embodiment 1. The specific process was as shown in FIG. 6.

### Experimental Example 1

The experimental results of embodiment 1, comparative example 1, comparative example 2, and comparative example 3 were statistically collected. The grades and recovery rates of fluorite (CaF₂) and rare earth (REO) in the products at each stage were compared. The results were as shown in Table 2.

TABLE 2

| | | Yield | Grade (%) | | Recovery rate (%) | |
|---|---|---|---|---|---|---|
| Solution | Name | (%) | CaF₂ | REO | CaF₂ | REO |
| Embodiment | Sulfide | 8.78 | 3.68 | 1.39 | 2.00 | 8.10 |
| 1 | Mixed | 10.84 | 86.22 | 5.52 | 57.89 | 39.77 |
| | concentrate | | | | | |
| | Middlings | 15.03 | 29.78 | 2.06 | 27.70 | 20.55 |
| | Tailings | 65.35 | 3.07 | 0.73 | 12.41 | 31.58 |
| | Raw ores | 100.00 | 16.15 | 1.51 | 100.00 | 100.00 |
| Comparative | Sulfide | 8.72 | 3.68 | 1.25 | 1.99 | 6.96 |
| example 1 | Mixed | 5.30 | 82.45 | 5.12 | 27.05 | 17.30 |
| | concentrate | | | | | |
| | Middlings | 15.08 | 48.66 | 2.61 | 45.41 | 25.12 |
| | Tailings | 70.90 | 5.82 | 1.12 | 25.56 | 50.62 |
| | Raw ores | 100.00 | 16.16 | 1.57 | 100.00 | 100.00 |
| Comparative | Sulfide | 8.38 | 3.69 | 1.36 | 1.92 | 7.45 |
| example 2 | Mixed | 11.71 | 62.09 | 4.99 | 45.09 | 38.21 |
| | concentrate | | | | | |
| | Middlings | 15.69 | 35.65 | 2.26 | 34.69 | 23.21 |
| | Tailings | 64.22 | 4.44 | 1.03 | 18.30 | 31.12 |
| | Raw ores | 100.00 | 16.13 | 1.53 | 100.00 | 100.00 |
| Comparative | Sulfide | 8.68 | 3.68 | 1.25 | 1.97 | 7.19 |
| example 3 | Rare earth | 3.02 | 57.19 | 6.45 | 10.65 | 12.91 |
| | concentrate | | | | | |
| | Fluorite | 5.27 | 77.45 | 3.12 | 25.17 | 10.89 |
| | concentrate | | | | | |
| | Middlings 1 | 3.01 | 43.61 | 2.65 | 8.11 | 5.30 |
| | Middlings 2 | 10.32 | 45.66 | 2.02 | 29.06 | 13.82 |
| | Tailings | 69.70 | 5.82 | 1.08 | 25.04 | 49.91 |
| | Raw ores | 100.00 | 16.21 | 1.51 | 100.00 | 100.00 |

From Table 2, it can be seen that compared with comparative example 1, the grades of REO and CaF₂ of the mixed concentrate (i.e., rare earth and fluorite mixed concentrate) obtained in embodiment 1 are 0.4% and 3.77% higher, respectively, and the recovery rates of REO and CaF₂ are 22.46% and 30.84% higher, respectively; compared with comparative example 2, the grades of REO and CaF₂ of the rare earth and fluorite mixed concentrate obtained in embodiment 1 are 0.53% and 24.13% higher, respectively, and the recovery rates of REO and CaF₂ are 1.56% and 12.80% higher, respectively.

In the rare earth concentrate firstly floated in comparative example 3, the grade of REO is only 6.45% and the recovery rate of REO is only 12.91%. In the fluorite concentrate floated from the rare earth tailings, the grade of CaF₂ and the recovery rate of CaF₂ are 77.45% and 25.17%, respectively. It can be seen that the method in comparative example 3 cannot firstly obtain better rare earth concentrate indicators, and the fluorite concentrate indicators are also poor.

From the experimental results of embodiment 1 and comparative examples 1-3, it can be seen that the simultaneous use of the collector CRF and the inhibitor DRF can effectively improve the ore dressing indicators of the mixed concentrate of rare earth and fluorite in the fluorite-type rare earth ores.

### Comparative Example 4

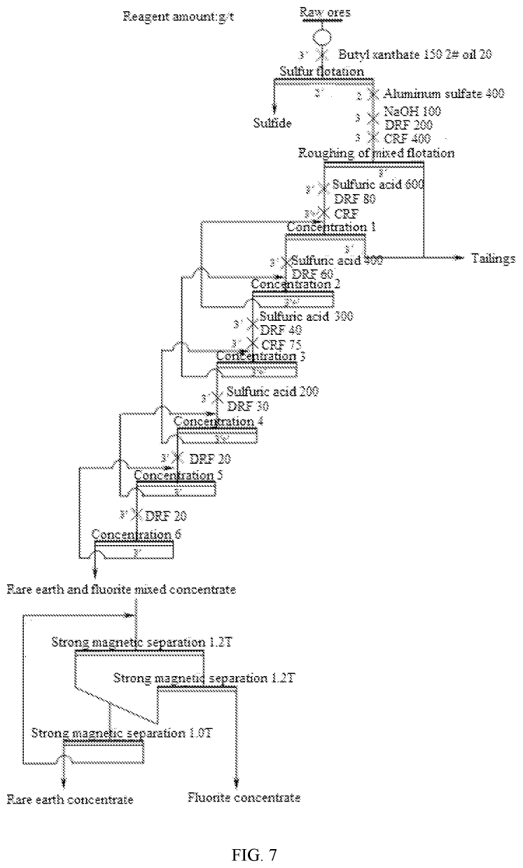

Comparative example 4 was adopted and compared with embodiment 2. The rare earth and fluorite mixed concentrate adopted in comparative example 4 was the same as that in embodiment 2. The specific process was as shown in FIG. 7. The difference between comparative example 4 and embodiment 2 was that magnetic separation was directly performed on the obtained rare earth and fluorite mixed concentrate in comparative example 4. The steps of magnetic separation included:

Performing roughing and scavenging of strong magnetic separation on a rare earth and fluorite mixed concentrate at a magnetic field intensity of 1.2T to obtain a roughing concentrate, a scavenging concentrate, and a fluorite concentrate; and combining the roughing concentrate and the scavenging concentrate, and then performing concentration of strong magnetic separation at a magnetic field intensity of 1.0T. The obtained magnetic product was a rare earth concentrate. The middlings were returned to roughing of strong magnetic separation.

### Experimental Example 2

The experimental results of embodiment 2 and comparative example 4 were statistically collected. The grades and recovery rates of CaF₂ and REO in the products at each stage were compared. The results were as shown in FIG. 3.

TABLE 3

| | | Yield | Grade (%) | | Recovery rate (%) | |
|---|---|---|---|---|---|---|
| Solution | Name | (%) | CaF₂ | REO | CaF₂ | REO |
| Embodiment | Sulfide | 7.80 | 3.94 | 1.47 | 1.90 | 7.53 |
| 2 | Rare earth | 1.48 | 18.12 | 54.21 | 1.65 | 52.56 |
| | concentrate | | | | | |
| | Fluorite | 11.89 | 92.34 | 1.07 | 67.77 | 8.35 |
| | concentrate | | | | | |
| | Tailings | 78.84 | 5.89 | 0.61 | 28.67 | 31.56 |
| | Raw ores | 100.00 | 16.19 | 1.52 | 100.00 | 100.00 |
| Comparative | Sulfide | 8.13 | 3.74 | 1.48 | 1.89 | 7.91 |
| example 4 | Rare earth | 1.19 | 30.31 | 44.96 | 2.25 | 35.20 |
| | concentrate | | | | | |
| | Fluorite | 12.10 | 90.78 | 3.12 | 68.36 | 24.83 |
| | concentrate | | | | | |
| | Tailings | 78.62 | 5.62 | 0.62 | 27.50 | 32.06 |
| | Raw ores | 100.04 | 16.07 | 1.52 | 100.00 | 100.00 |

From Table 3, it can be seen that compared with the method of direct magnetic separation of the fluorite and rare earth mixed concentrate (i.e., the method in comparative example 4), the method of firstly performing flotation and then performing magnetic separation on the rare earth-fluorite mixed concentrate (i.e., the method in embodiment 2) can significantly improve the indicators of the obtained rare earth concentrate.

The foregoing descriptions are merely specific implementations of the present disclosure, but the protection scope of the present disclosure is not limited thereto. Changes or replacements that any person skilled in the art could conceive of within the technical scope of the present disclosure shall be included in the protection scope of the present disclosure. Therefore, the protection scope of the present disclosure shall be subject to the protection scope of the claims.

1. A flotation reagent, comprising:
a collector comprising fatty acid, alkyl aminopropionic acid, and sulfobetaine; and
an inhibitor comprising an aromatic sulfonate polycondensate, water glass, lignosulfonate, and a tannin extract.

2. The flotation reagent according to claim 1, wherein
the fatty acid comprises at least one of oleic acid, oxidized paraffin soap, tall oil, and naphthenic acid.

3. The flotation reagent according to claim 1, wherein
the molecular formula of the alkyl aminopropionic acid is RNHCH₂CH₂COOH,
where R is substituted or unsubstituted C₁₀-C₁₈ hydrocarbyl.

4. The flotation reagent according to claim 3, wherein
in the molecular formula, R is substituted C₁₀-C₁₈ hydrocarbyl, and the substituted C₁₀-C₁₈ hydrocarbyl is obtained by respectively and independently substituting one or more hydrogen atoms in unsubstituted C₁₀-C₁₈ hydrocarbyl with halogen, alkyl, methoxy, aryl, or heteroaryl.

5. The flotation reagent according to claim 1, wherein
the molecular formula of the sulfobetaine is CH₃ (CH₂)ₙ₁N⁺(CH₃)₂(CH₂)ₘ₁SO₃⁻,
where n1=7-17, and n1 is an integer;
m1≥2, and m1 is an integer.

6. The flotation reagent according to claim 1, wherein
the molecular formula of the sulfobetaine is 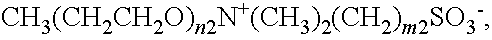
where n2=7-17, and n2 is an integer;
m2≥2, and m2 is an integer.

7. The flotation reagent according to claim 1, wherein the aromatic sulfonate polycondensate is a sodium salt of a 2-naphthalenesulfonic acid-formaldehyde polymer.

8. The flotation reagent according to claim 7, wherein
the sodium salt of the 2-naphthalenesulfonic acid-formaldehyde polymer has a structure expressed by formula (I): 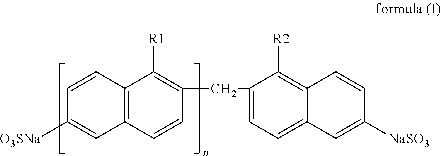
where R1 is selected from the group consisting of hydrogen atom, methyl and benzyl;
R2 is the same as R1;
n=1-5, and n is an integer.

9. The flotation reagent according to claim 1, wherein
the aromatic sulfonate polycondensate has a structure expressed by formula (II): 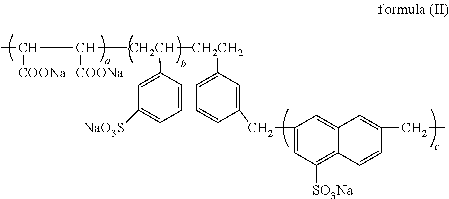
where a+b+c=80-400, and a, b, and c are all positive integers.

10. The flotation reagent according to claim 1, wherein
the weight ratio of the fatty acid to the alkyl aminopropionic acid to the sulfobetaine is (5-8):(1-3):(1-3); and/or,
the weight ratio of the aromatic sulfonate polycondensate to the water glass to the lignosulfonate to the tannin extract is (30-50):(20-40):(10-30):(5-15).

11. Application of the flotation reagent according to claim 1 to flotation separation of fluorite-type rare earth ores.

12. The application according to claim 11, wherein
the flotation reagent is applied to synchronously recovering fluorite and rare earth from the fluorite-type rare earth ores.

13. The application according to claim 11, wherein
the fluorite-type rare earth ores comprise fluorite, rare earth, and gangue minerals.

14. A method for synchronously recovering fluorite and rare earth from fluorite-type rare earth ores, comprising:
grinding raw ores to obtain first slurry;
regulating the first slurry to be alkaline to obtain second slurry;
adding a first inhibitor to the second slurry, and performing first stirring and mixing to obtain third slurry, the first inhibitor comprising an aromatic sulfonate polycondensate, water glass, lignosulfonate, and a tannin extract;
adding a first collector to the third slurry, and performing second stirring and mixing to obtain fourth slurry, the first collector comprising fatty acid, alkyl aminopropionic acid, and sulfobetaine;
performing first aerated flotation on the fourth slurry to obtain a first foam product; and
performing concentration on the first foam product to obtain a mixed concentrate comprising fluorite and rare earth.

15. The method according to claim 14, wherein
the fluorite-type rare earth ores comprise gangue minerals in addition to the fluorite and the rare earth.

16. The method according to claim 14, wherein the regulating the first slurry to be alkaline comprises:
regulating the pH value of the first slurry to 8-9 by using a first regulator.

17. The method according to claim 14, wherein the method further comprises:
regulating the mixed concentrate to be acidic to obtain fifth slurry;
adding a second inhibitor to the fifth slurry, and performing third stirring and mixing to obtain sixth slurry, the second inhibitor comprising an aromatic sulfonate polycondensate, water glass, lignosulfonate, and a tannin extract;
adding a second collector to the sixth slurry, and performing fourth stirring and mixing to obtain seventh slurry, the second collector comprising fatty acid, alkyl aminopropionic acid, and sulfobetaine; and
performing second aerated flotation on the seventh slurry to obtain a second foam product and a bottom product, the second foam product being a rare-earth-enriched substance, the bottom product being a fluorite-enriched substance.

18. The method according to claim 17, wherein the method further comprises:
performing first strong magnetic separation on the rare-earth-enriched substance to obtain a magnetic product, the magnetic product being a rare earth concentrate.

19. The method according to claim 17, wherein the method further comprises:
performing second strong magnetic separation on the fluorite-enriched substance to obtain a non-magnetic product, the non-magnetic product being a fluorite concentrate.

20. The method according to claim 17, wherein the regulating the mixed concentrate to be acidic comprises:
regulating the pH value of the mixed concentrate to 4-5 by using a second regulator.
